(19) United States
(12) Patent Application Publication
(10) Pub. No.: US 2023/0378829 A1
(43) Pub. Date: Nov. 23, 2023

(54) ROTOR, MOTOR, BLOWER, AIR CONDITIONER, AND MANUFACTURING METHOD OF ROTOR

(71) Applicant: Mitsubishi Electric Corporation, Tokyo (JP)

(72) Inventors: Yuji HIROSAWA, Tokyo (JP); Masahiro NIGO, Tokyo (JP)

(21) Appl. No.: 18/027,479

(22) PCT Filed: Nov. 19, 2020
(86) PCT No.: PCT/JP2020/043191

§ 371 Date: Mar. 21, 2023

(51) Int. Cl. H02K 1/276; F24F 1/0018; F04D 25/06; H02K 1/28; H02K 21/16; H02K 15/03; H02K 15/12

(52) U.S. Cl. CPC H02K 1/276; F24F 1/0018; F04D 25/06; H02K 1/28; H02K 21/16; H02K 15/03; H02K 15/12; H02K 2213/03

(57) ABSTRACT

A rotor includes a first rotor core, a plurality of permanent magnets, a plurality of second rotor cores, and a first resin part. Each of the plurality of permanent magnets has a first surface in contact with a first radial-direction-outward-facing surface of the first rotor core and a second surface facing outward in a radial direction. Each of the plurality of second rotor cores has a surface facing inward in the radial direction. The surface of each of the plurality of second rotor cores facing inward in the radial direction is in contact with the second surface of corresponding one of the plurality of permanent magnets. The first resin part is provided between adjoining second rotor cores among the plurality of second rotor cores.

### CROSS-REFERENCE TO RELATED APPLICATION

This application is a U.S. National Stage Application of International Application No. PCT/JP2020/043191 filed on Nov. 19, 2020, the contents of which are incorporated herein by reference.

### TECHNICAL FIELD

The present disclosure relates to a rotor, a motor, a blower, an air conditioner, and a manufacturing method of the rotor.

### BACKGROUND

As a rotor of a motor, there has been known a rotor including permanent magnets and a rotor core to which the permanent magnets are attached. See, Patent Reference 1, for example. The rotor core in the Patent Reference 1 includes magnet insertion parts in which the permanent magnets are inserted.

### Patent Reference

Patent Reference 1: Japanese Patent Application Publication No. 2013-74660

However, in the rotor in the Patent Reference 1, due to magnetic attractive force, the permanent magnet makes close contact with one of the surface of the magnet insertion part facing inward in a radial direction and the surface of the magnet insertion part facing outward in the radial direction, and a gap is formed between the permanent magnet and the other surface. In this case, there is a problem in that the magnetic flux amount of the magnetic flux of the permanent magnet flowing from the rotor into the stator of the motor decreases.

### SUMMARY

An object of the present disclosure is to prevent the decrease in the magnetic flux amount of the magnetic flux of the permanent magnet.

A rotor according to an aspect of the present disclosure includes a first rotor core, a plurality of permanent magnets each having a first surface in contact with a first radial-direction-outward-facing surface of the first rotor core and a second surface facing outward in a radial direction, a plurality of second rotor cores each having a surface facing inward in the radial direction, the surface of each of the plurality of second rotor cores facing inward in the radial direction being in contact with the second surface of corresponding one of the plurality of permanent magnets, and a first resin part provided at a region between adjoining second rotor cores among the plurality of second rotor cores. The region is located on an inner side in the radial direction with respect to a second radial-direction-outward facing surface which is a surface of the second rotor core facing outward in the radial direction. The region is located on an outer side in the radial direction with respect to the first surface.

According to the present disclosure, the decrease in the magnetic flux amount of the magnetic flux of the permanent magnet can be prevented.

### BRIEF DESCRIPTION OF THE DRAWINGS

FIG. 1 is a plan view showing part of the configuration of a motor according to a first embodiment.

FIG. 2 is a plan view showing part of the configuration of a rotor of the motor shown in FIG. 1.

FIG. 3 is a side sectional view showing the configuration of the rotor according to the first embodiment.

FIG. 4 is an enlarged plan view showing the configuration around a tooth tip part of a stator core shown in FIG. 1.

FIG. 5 is a flowchart showing a manufacturing process of the rotor according to the first embodiment.

FIGS. 6(A) to 6(C) are schematic diagrams showing an example of a manufacturing process of an intermediate structure of the rotor.

FIG. 7 is a plan view showing the configuration of a rotor according to a first modification of the first embodiment.

FIG. 8 is a plan view showing the configuration of a rotor according to a second modification of the first embodiment.

FIG. 9 is an enlarged plan view showing the configuration of a rotor according to a second embodiment.

FIG. 10 is a plan view showing the configuration of a rotor according to a third embodiment.

FIG. 11 is a plan view showing the configuration of a rotor according to a modification of the third embodiment.

FIG. 12 is a cross-sectional view showing the configuration of a rotor according to a fourth embodiment.

FIG. 13 is a diagram showing the configuration of a blower according to a fifth embodiment.

FIG. 14 is a diagram showing the configuration of an air conditioner according to a sixth embodiment.

### DETAILED DESCRIPTION

A rotor, a motor, a blower, an air conditioner, and a manufacturing method of the rotor according to each embodiment of the present disclosure will be described below with reference to the drawings. The following embodiments are just examples and it is possible to appropriately combine embodiments and appropriately modify each embodiment.

An xyz orthogonal coordinate system is shown as needed in the drawings in order to facilitate the understanding of the relationship between drawings. A z-axis is a coordinate axis parallel to an axis C of the rotor. An x-axis is a coordinate axis orthogonal to the z-axis. A y-axis is a coordinate axis orthogonal to both of the x-axis and the z-axis.

(First Embodiment)

(Motor)

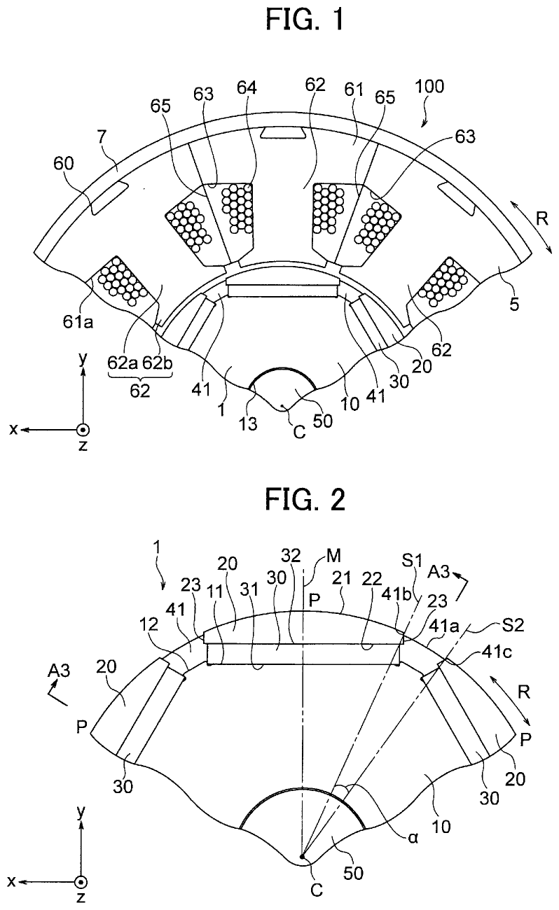

FIG. 1 is a plan view showing the configuration of a motor 100 according to a first embodiment. The motor 100 is a permanent magnet synchronous motor. The motor 100 includes a rotor 1 and a stator 5. The rotor 1 is arranged on an inner side relative to the stator 5. Namely, the motor 100 is a motor of the inner rotor type. An air gap is formed between the rotor 1 and the stator 5. The air gap is a predetermined gap in a range of 0.3 mm to 1.0 mm, for example.

(Rotor)

The rotor 1 includes a first rotor core 10, a plurality of second rotor cores 20, a plurality of permanent magnets 30, a resin part 41 as a first resin part, and a shaft 50. The rotor 1 is rotatable about the axis C of the shaft 50.

The shaft 50 extends in the z-axis direction. The shaft 50 is connected to a hollow part 13 of the first rotor core 10. The shaft 50 is connected to the hollow part 13 by means of shrink fitting, press fitting or the like, for example. Thus, rotational energy when the shaft 50 rotates is transmitted to the first rotor core 10. Incidentally, in the following description, the z-axis direction is referred to also as an “axial direction”. Further, a direction along a circumference of a circle centering at the axis C is referred to as a “circumferential direction” (for example, circumferential direction R indicated by the arrow in FIG. 1), and the direction of a straight line orthogonal to the z-axis direction and passing through the axis C is referred to as a “radial direction”.

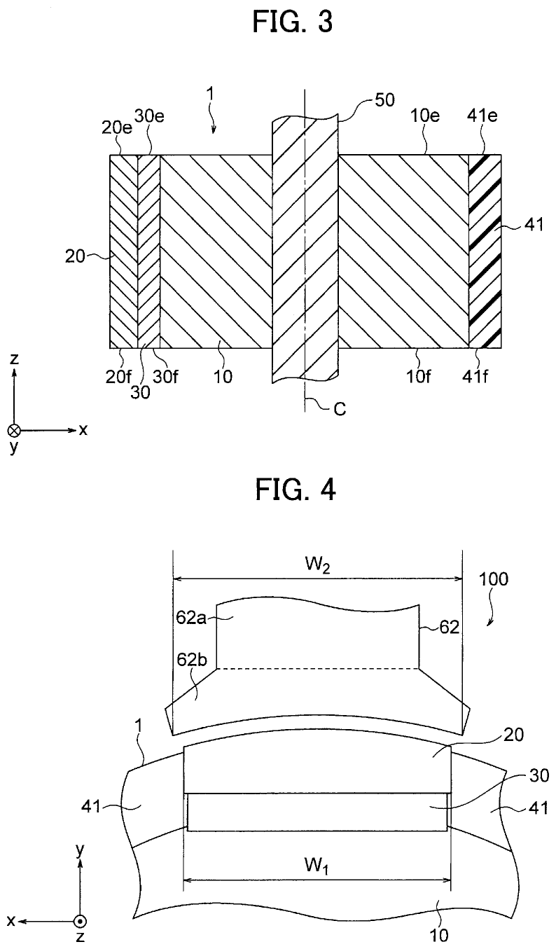

FIG. 2 is a plan view showing part of the configuration of the rotor 1 according to the first embodiment. FIG. 3 is a side sectional view showing the configuration of the rotor 1 according to the first embodiment. As shown in FIGS. 2 and 3, the first rotor core 10 is supported by the shaft 50. The first rotor core 10 has a surface 11 facing outward in the radial direction as a first radial-direction-outward-facing surface and has a plurality of projection parts 12.

In the first embodiment, the surface 11 facing outward in the radial direction is a flat surface that is elongated in the z-axis direction. Here, when M represents a magnetic pole central line extending in the radial direction to connect a magnetic pole P formed in the permanent magnet 30 of the rotor 1 and the axis C of the shaft 50, the surface 11 facing outward in the radial direction is a flat surface in parallel with the z-axis direction and also in parallel with a straight line extending in a direction orthogonal to the magnetic pole central line M.

The projection part 12 projects outward in the radial direction from the surface 11 facing outward in the radial direction. The projection part 12 supports an end face of the permanent magnet 30 in the circumferential direction R. Incidentally, as shown in FIG. 8 which will be explained later, the surface 11b facing outward in the radial direction may also be a curved surface (for example, concave surface in a semicylindrical shape).

The plurality of second rotor cores 20 are arranged on the outer side in the radial direction relative to the first rotor core 10 across the permanent magnets 30. The second rotor core 20 has a surface 21 facing outward in the radial direction as a second radial-direction-outward-facing surface and a surface 22 facing inward in the radial direction as a second radial-direction-inward-facing surface.

In the first embodiment, the surface 21 facing outward in the radial direction is a convex surface in a semicylindrical shape. The surface 22 facing inward in the radial direction is a flat surface that is elongated in the z-axis direction. Further, the surface 22 facing inward in the radial direction is a flat surface in parallel with the z-axis direction and also in parallel with a straight line extending in a direction orthogonal to the magnetic pole central line M. Incidentally, as shown in FIG. 8 which will be explained later, the surface 22b facing inward in the radial direction may also be a curved surface (for example, convex surface in a semicylindrical shape).

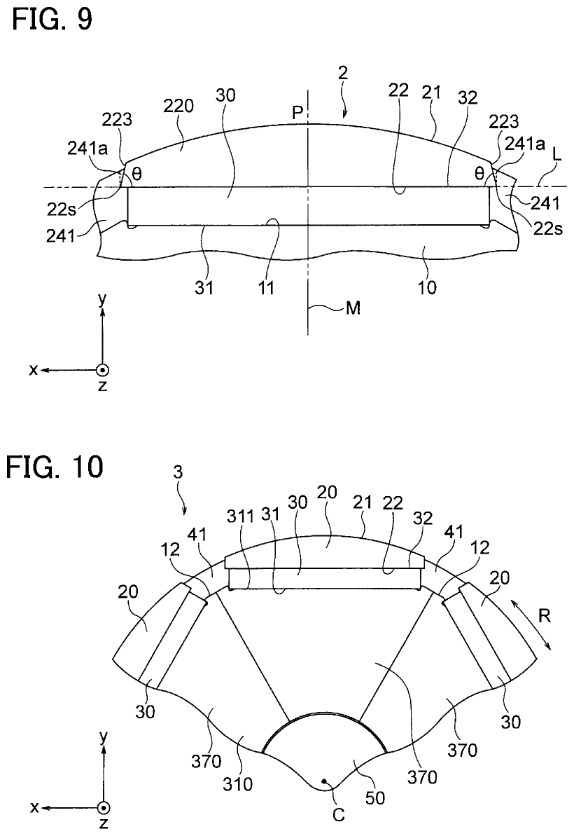

The second rotor core 20 further has side faces 23 connecting the surface 21 facing outward in the radial direction and the surface 22 facing inward in the radial direction. In the first embodiment, an angle formed by the surface 22 facing inward in the radial direction and the side face 23 is 90 degrees. Incidentally, as shown in FIG. 9 which will be explained later, the angle formed by the surface 22 facing inward in the radial direction and the side face 223 may also be smaller than 90 degrees.

Each of the first rotor core 10 and the second rotor cores 20 includes a plurality of electromagnetic steel sheets (not shown) stacked in the z-axis direction. A sheet thickness of each of electromagnetic steel sheets used for the first rotor core 10 and the second rotor cores 20 is a predetermined thickness in a range of 0.1 mm to 0.7 mm, for example, and is 0.35 mm, for example.

In the first embodiment, the rotor 1 includes six permanent magnets 30, for example. Incidentally, the permanent magnet 30 is arranged between the first rotor core 10 and the second rotor core 20. Incidentally, the number of the permanent magnets 30 is not limited to six. The number may be any number larger than or equal to two.

The permanent magnet 30 has a first surface 31 and a second surface 32. The first surface 31 is in contact with the surface 11 of the first rotor core 10 facing outward in the radial direction. The second surface 32 is in contact with the surface 22 of the second rotor core 20 facing inward in the radial direction. Accordingly, an air layer as a gap does not exist between the permanent magnet 30 and the first rotor core 10 or between the permanent magnet 30 and the second rotor core 20. In general, the magnetic permeability of an air layer is lower than the magnetic permeability of a metallic material. In the rotor 1 according to the first embodiment, an air layer does not exist between the permanent magnet 30 and the first rotor core 10 or between the permanent magnet 30 and the second rotor core 20. With this configuration, the decrease in the magnetic flux amount of the magnetic flux flowing from the permanent magnet 30 into a coil 64 (see FIG. 1) of the stator 5 (hereinafter referred to also as “interlinkage magnetic flux”) can be prevented.

The first surface 31 of the permanent magnet 30 and the surface 11 of the first rotor core 10 facing outward in the radial direction are both flat surfaces and are in close contact with each other. Accordingly, no gap occurs between the permanent magnet 30 and the first rotor core 10. Further, the second surface 32 of the permanent magnet 30 and the surface 22 of the second rotor core 20 facing inward in the radial direction are also both flat surfaces and are in close contact with each other. Accordingly, no gap occurs between the permanent magnet 30 and the second rotor core 20. Since the permanent magnet 30 is in close contact with the first rotor core 10 and the second rotor core 20 as above, the decrease in the magnetic flux amount of the interlinkage magnetic flux can be prevented.

In the first embodiment, the permanent magnet 30 is a rectangular parallelepiped. Namely, the shape of an end face of the permanent magnet 30 in the axial direction is a rectangular shape. Thus, in the first embodiment, the first surface 31 and the second surface 32 of the permanent magnet 30 are both flat surfaces. Accordingly, the permanent magnet 30 having a simple shape can be placed in close contact with the first rotor core 10 and the second rotor core 20. Further, since the permanent magnet 30 is a rectangular parallelepiped, the structure of the mold for molding the permanent magnet 30 can be simplified. Incidentally, the first surface 31 and the second surface 32 are not limited to flat surfaces but may also be surfaces in different shapes. For example, as shown in FIG. 8 which will be explained later, the first surface 31b and the second surface 32b may also be concave surfaces in semicylindrical shapes.

In the first embodiment, the permanent magnet 30 is a sintered magnet. Namely, in the first embodiment, the permanent magnet 30 is formed by means of powder metallurgy. In general, the density of the sintered magnet is higher than the density of a bond magnet containing resin. Accordingly, magnetic force of the permanent magnet 30 can be increased.

On the other hand, the dimensional accuracy of the sintered magnet is lower than the dimensional accuracy of the bond magnet. Thus, when the sintered magnet is inserted in a rotor core including a magnet insertion part, a gap is likely to occur between the magnet insertion part and the sintered magnet, and thus the magnet magnetic flux amount of the permanent magnet decreases. In the first embodiment, the permanent magnet 30 is in close contact with the first rotor core 10 and the second rotor core 20 as mentioned above. Accordingly, no gap occurs between the permanent magnet 30 and the first rotor core 10 or between the permanent magnet 30 and the second rotor core 20. Thus, the decrease in the magnetic flux amount of the interlinkage magnetic flux can be prevented even when the permanent magnet 30 is a sintered magnet.

The permanent magnet 30 is a rare-earth magnet. Specifically, the permanent magnet 30 is a neodymium rare-earth magnet containing neodymium (Nd), iron (Fe) and boron (B). Accordingly, a maximum energy product of the neodymium rare-earth magnet is greater than the maximum energy product of a magnet of a different type. Here, the maximum energy product means the maximum value of an energy product which is the product of the magnetic field and the magnetic flux density of the permanent magnet. Namely, the maximum energy product is an index value indicating a target of a maximum magnet magnetic flux amount derivable from one permanent magnet. Thus, in the case where the permanent magnet 30 is a neodymium rare-earth magnet, the magnetic force of the permanent magnet 30 can be increased.

On the other hand, the neodymium rare-earth magnet has a characteristic of being easily rusted in reaction with oxygen. In the first embodiment, the permanent magnet 30 is in contact with the first rotor core 10 and the second rotor core 20 as described above, and thus the area of exposure of the permanent magnet 30 to air decreases. Accordingly, the occurrence of rust on the permanent magnet 30 can be inhibited and excellent magnetic properties of the permanent magnet 30 can be maintained.

The resin part 41 is provided so as to fill a gap between two second rotor cores 20 adjoining each other in the circumferential direction R among the plurality of second rotor cores 20. With this configuration, the plurality of second rotor cores 20 and the plurality of permanent magnets 30 can be fixed to the first rotor core 10.

Further, since the resin part 41 fills the gap between two second rotor cores 20 adjoining each other in the circumferential direction R, magnetic resistance between the two second rotor cores 20 increases, and thus leakage flux between magnetic poles P adjoining each other in the circumferential direction R is inhibited. Thus, the magnetic flux from the permanent magnet 30 can be inhibited from short-circuiting between adjoining magnetic poles P without flowing into the stator 5. Accordingly, the decrease in the magnetic flux amount of the interlinkage magnetic flux can be prevented.

The resin part 41 is formed of a thermoplastic resin. For example, the resin part 41 is formed of at least one of PBT (PolyButylene Terephthalate) resin, PPS (PolyPhenylene Sulfide) resin, PET (PolyEthylene Terephthalate) resin and LCP (Liquid Crystal Polymer) resin. Incidentally, the resin part 41 may also be formed of a different thermoplastic resin or a resin other than a thermoplastic resin.

The resin part 41 has a surface 41a facing outward in the radial direction as a third radial-direction-outward-facing surface. The surface 41a facing outward in the radial direction is a curved surface (convex surface in a semicylindrical shape in the example shown in FIG. 2). Here, a first straight line as a straight line connecting the axis C and one end part 41b in the circumferential direction R of the surface 41a of the resin part 41 facing outward in the radial direction is defined as a first straight line S1, and a second straight line as a straight line connecting the axis C and the other end part 41c in the circumferential direction R of the surface 41a facing outward in the radial direction is defined as a second straight line S2. Further, an angle on the resin part 41 side between the first straight line S1 and the second straight line S2 is assumed to be α. The angle α represents an angular range of the resin part 41, which fills the gap between two second rotor cores 20 adjoining each other in the circumferential direction R, about the axis C. In other words, the angle α represents an angular range of the resin part 41, situated between adjoining magnetic poles P, about the axis C.

Here, when the number of tooth parts 62 (see FIG. 1) of the stator 5 is T and the number of magnetic poles P of the rotor 1 (hereinafter referred to also as a “magnetic pole number”) is N, the angle α satisfies the following expression (1):

α>360°(T−N)/(T·N) (1)

Accordingly, it is possible to secure a sufficient length of the permanent magnet 30 in the circumferential direction R and thereby secure sufficient magnetic force of the rotor 1 while firmly fixing the plurality of second rotor cores 20 and the plurality of permanent magnets 30 to the first rotor core 10.

As shown in FIG. 3, one end face 41e of the resin part 41 in the axial direction is flush with one end face 10e of the first rotor core 10 in the axial direction, one end face 20e of the second rotor core 20 in the axial direction, and one end face 30e of the permanent magnet 30 in the axial direction. Further, the other end face 41f of the resin part 41 in the axial direction is flush with the other end face 10f of the first rotor core 10 in the axial direction, the other end face 20f of the second rotor core 20 in the axial direction, and the other end face 30f of the permanent magnet 30 in the axial direction. Accordingly, the plurality of second rotor cores 20 and the plurality of permanent magnets 30 can be firmly fixed to the first rotor core 10.

The resin part 41 may be formed integrally with another resin part included in the rotor 1. For example, the resin part 41 may be connected to another resin part embedded between the shaft 50 and the first rotor core 10. Further, as shown in FIG. 12 which will be explained later, the resin part 41 may be formed integrally with another resin part (second resin part 442, 443 in FIG. 12) arranged to cover end faces of the first rotor core 10, the second rotor cores 20 and the permanent magnets 30 in the axial direction.

(Stator)

Next, the configuration of the stator 5 will be described. As shown in FIG. 1, the stator 5 includes a stator core 60.

The stator core 60 includes a plurality of electromagnetic steel sheets (not shown) stacked in the z-axis direction. In the first embodiment, the sheet thickness of each of the electromagnetic steel sheets used for the stator core 60 is the same as the sheet thickness of each of the electromagnetic steel sheets used for the first rotor core 10 and the second rotor cores 20. Among the plurality of electromagnetic steel sheets stacked in the z-axis direction, two electromagnetic steel sheets adjoining in the z-axis direction are fixed together by means of crimping or the like. The stator core 60 is fixed to a frame 7. Incidentally, the sheet thickness of each of the electromagnetic steel sheets used for the stator core 60 may also differ from the sheet thickness of each of the electromagnetic steel sheets 15 used for the first rotor core 10 and the second rotor cores 20 as long as the sheet thickness is a predetermined thickness in a range of 0.1 mm to 0.7 mm.

The stator core 60 includes a yoke part 61, a plurality of tooth parts 62 and a plurality of slot parts 63.

The yoke part 61 extends in the circumferential direction R. The plurality of tooth parts 62 are arranged at even angular intervals in the circumferential direction R. The coil 64 is wound around each of the plurality of tooth parts 62. Incidentally, the number of the plurality of tooth parts 62 may be any number larger than or equal to 2. The slot part 63 is a space formed between two tooth parts 62 adjoining each other in the circumferential direction R among the plurality of tooth parts 62.

FIG. 4 is an enlarged plan view showing the configuration around the tooth part 62 of the motor 100 according to the first embodiment. As shown in FIGS. 1 and 4, the tooth part 62 includes a tooth extension part 62a and a tooth tip part 62b. The tooth extension part 62a extends inward in the radial direction from an inner peripheral surface 61a of the yoke part 61. The tooth tip part 62b is arranged on the inner side in the radial direction relative to the tooth extension part 62a. The tooth tip part 62b is a part of the tooth part 62 that is wider in the circumferential direction R than the tooth extension part 62a.

As shown in FIG. 4, when the length of the second rotor core 20 in the circumferential direction R is W₂ and the length of the tooth tip part 62b in the circumferential direction R is W₂, the length W₂ is less than the length W₂. With this configuration, when the magnetic flux from the permanent magnet 30 flows into the tooth tip part 62b through the second rotor core 20, leakage of the magnetic flux is unlikely to occur. Namely, the decrease in the magnetic flux amount of the interlinkage magnetic flux flowing from the permanent magnet 30 into the coil 64 (see FIG. 1) through the tooth part 62 is prevented, and thus output torque of the motor 100 can be increased. Incidentally, it is sufficient that the length W₁ is less than or equal to the length W₂. The length W₁ may also be equal to the length W₂. Namely, it is sufficient that the length W₁ and the length W₂ satisfy the following expression (2):

W₁≤W₂ (2)

As shown in FIG. 1, the stator core 60 further includes the coil 64 and an insulation part 65 arranged in the slot part 63. The coil 64 is a magnet wire, for example. The winding method of the coil 64 is, for example, concentrated winding in which the coil 64 is directly wound around the tooth part 62 via the insulation part 65. The number of turns and the wire diameter of the coil 64 are determined based on characteristics required of the motor 100 (rotation speed, torque, or the like), voltage specifications, and cross-sectional area of the slot part 63. Electric current at a frequency synchronized with an instructed rotation speed is applied to the coil 64, by which a rotating magnetic field for rotating the rotor 1 is generated. The insulation part 65 is insulative film, for example.

(Manufacturing Method of Rotor)

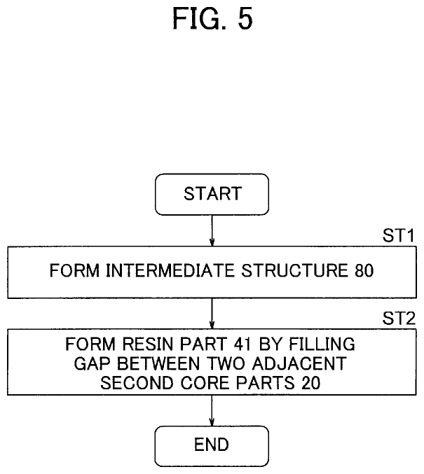

Next, a manufacturing method of the rotor 1 will be described with reference to FIG. 5. FIG. 5 is a flowchart showing a manufacturing process of the rotor 1. Incidentally, the manufacturing method of the rotor 1 described below is just an example and a different manufacturing method may also be employed.

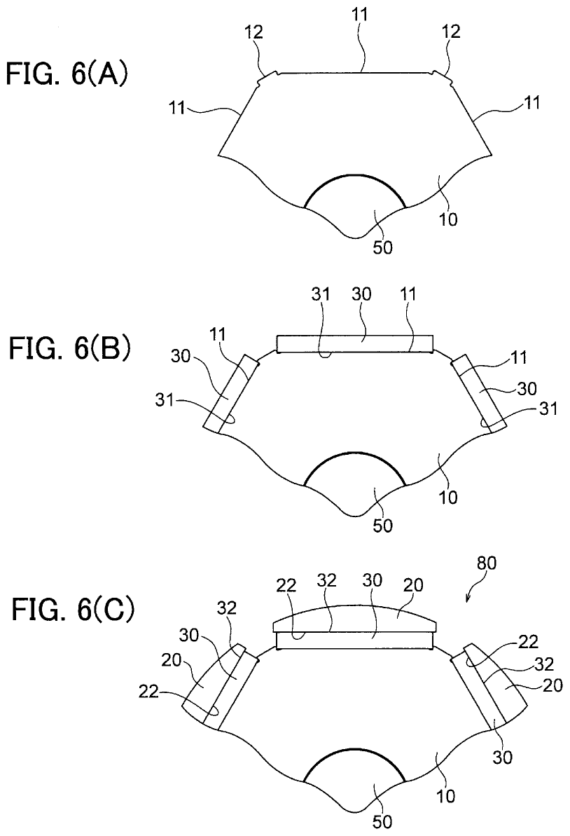

In step ST1, a first structure including the first rotor core 10, the plurality of second rotor cores 20 and the plurality of permanent magnets 30, that is, an intermediate structure 80 shown in FIG. 6(C) which will be explained later, is formed. The intermediate structure 80 is a structure that is formed during the manufacturing process of the rotor 1. Incidentally, details of a manufacturing process for forming the intermediate structure 80 will be described later.

In step ST2, the resin part 41 is formed by filling gaps between adjoining second rotor cores 20 among the plurality of second rotor cores 20 with resin. As above, in the manufacturing process of the intermediate structure 80, the positions of the permanent magnets 30 and the second rotor cores 20 are determined, and then the gaps each between two adjoining second rotor cores 20 is filled with the resin. Accordingly, the occurrence of a gap between the permanent magnet 30 and the first rotor core 10 and a gap between the permanent magnet 30 and the second rotor core 20 can be prevented.

Next, the manufacturing process of the intermediate structure 80 of the rotor 1 will be described with reference to FIGS. 6(A) to 6(C). FIGS. 6(A) to 6(C) are schematic diagrams showing the manufacturing process of the intermediate structure 80. In the manufacturing process of the intermediate structure 80, a mold for forming the resin part 41 shown in FIG. 2 is used. Incidentally, the order of steps in the manufacturing process of the intermediate structure 80 is not limited to the order shown in FIGS. 6(A), 6(B) and 6(C) but may also be a different order.

As shown in FIG. 6(A), the first rotor core 10 to which the shaft 50 is connected is placed in the mold.

As shown in FIG. 6(B), the first surfaces 31 of the plurality of permanent magnets 30 are brought into contact with the surfaces 11, which face outward in the radial direction, of the first rotor core 10 placed in the mold.

As shown in FIG. 6(C), the surfaces 22, which face inward in the radial direction, of the plurality of second rotor cores 20 are brought into contact with the second surfaces 32 of the plurality of permanent magnets 30. Thus, the intermediate structure 80 including the first rotor core 10, the plurality of permanent magnets 30 and the plurality of second rotor cores 20 is formed.

(Effect of First Embodiment)

According to the first embodiment described above, the first surface 31 of the permanent magnet 30 is in contact with the surface 11 of the first rotor core 10 facing outward in the radial direction, and the second surface 32 of the permanent magnet 30 is in contact with the surface 22 of the second rotor core 20 facing inward in the radial direction. Accordingly, no gap occurs between the permanent magnet 30 and the first rotor core 10 or between the permanent magnet 30 and the second rotor core 20. Thus, the decrease in the magnetic flux amount of the interlinkage magnetic flux can be prevented.

According to the first embodiment, the resin part 41 fills the gap between two second rotor cores 20 adjoining each other in the circumferential direction R among the plurality of second rotor cores 20. With this configuration, the plurality of second rotor cores 20 are fixed to the first rotor core 10. Further, since the gap between two second rotor cores 20 adjoining each other in the circumferential direction R is filled with the resin part 41, the magnetic resistance between the two second rotor cores 20 increases, and thus the leakage flux between two magnetic poles adjoining each other in the circumferential direction R is inhibited. Thus, it is possible to inhibit an event in which the magnetic flux from the permanent magnet 30 does not flow into the stator 5 but short-circuits between adjoining magnetic poles of the rotor 1. Accordingly, the magnetic flux amount of the interlinkage magnetic flux can be increased.

According to the first embodiment, the first surface 31 of the permanent magnet 30 and the surface 11 of the first rotor core 10 facing outward in the radial direction are parallel to each other, and the second surface 32 of the permanent magnet 30 and the surface 22 of the second rotor core 20 facing inward in the radial direction are parallel to each other. With this configuration, the occurrence of a gap between the permanent magnet 30 and the first rotor core 10 and a gap between the permanent magnet 30 and the second rotor core 20 can be prevented.

According to the first embodiment, the first surface 31 of the permanent magnet 30 and the surface 11 of the first rotor core 10 facing outward in the radial direction are flat surfaces, and the second surface 32 of the permanent magnet 30 and the surface 22 of the second rotor core 20 facing inward in the radial direction are flat surfaces. Accordingly, the occurrence of a gap between the permanent magnet 30 and the first rotor core 10 and a gap between the permanent magnet 30 and the second rotor core 20 can be prevented with the simple shape.

According to the first embodiment, the permanent magnet 30 is a rectangular parallelepiped. Accordingly, on the permanent magnet 30, the first surface 31 in contact with the surface 11 of the first rotor core 10 facing outward in the radial direction and the second surface 32 in contact with the surface 22 of the second rotor core 20 facing inward in the radial direction are flat surfaces. Thus, the occurrence of a gap between the permanent magnet 30 and the first rotor core 10 and a gap between the permanent magnet 30 and the second rotor core 20 can be prevented with the simple shape. Further, since the permanent magnet 30 is a rectangular parallelepiped, the structure of the mold for molding the permanent magnet 30 can be simplified.

According to the first embodiment, the permanent magnet 30 is a sintered magnet. Since the magnetic force of the sintered magnet is greater than the magnetic force of a bond magnet, the magnetic flux amount of the interlinkage magnetic flux can be increased. Here, the dimensional accuracy of the sintered magnet is lower than the dimensional accuracy of the bond magnet. However, in the first embodiment, the surface 11 of the first rotor core 10 facing outward in the radial direction is in contact with the first surface 31 of the permanent magnet 30 and the surface 22 of the second rotor core 20 facing inward in the radial direction is in contact with the second surface 32 of the permanent magnet 30 as described above. Thus, even if the permanent magnet 30 is a sintered magnet, no gap occurs between the permanent magnet 30 and the rotor core (i.e., the first rotor core 10 or the second rotor core 20), and thus the decrease in the magnetic flux amount of the interlinkage magnetic flux can be prevented.

According to the first embodiment, the permanent magnet 30 is a neodymium rare-earth magnet. Accordingly, the magnetic force of the rotor 1 can be increased. Here, the neodymium rare-earth magnet is more likely to react with oxygen compared to other types of magnets and thus is likely to rust. However, in the first embodiment, no gap occurs between the permanent magnet 30 and the first rotor core 10 or between the permanent magnet 30 and the second rotor core 20, and thus the permanent magnet 30 is unlikely to react with oxygen. Accordingly, even if the permanent magnet 30 is a neodymium rare-earth magnet, the permanent magnet 30 can be made unlikely to rust.

According to the first embodiment, the angle a representing the angular range of the resin part 41, situated between two magnetic poles P adjoining each other in the circumferential direction R, about the axis C satisfies the aforementioned expression (1) represented by the number T of tooth parts 62 of the stator core 60 and the number N of magnetic poles P of the rotor 1. Accordingly, it is possible to secure a sufficient length of the permanent magnet 30 in the circumferential direction R and thereby secure sufficient magnetic force of the rotor 1 while firmly fixing the plurality of second rotor cores 20 and the plurality of permanent magnets 30 to the first rotor core 10.

(First Modification of First Embodiment)

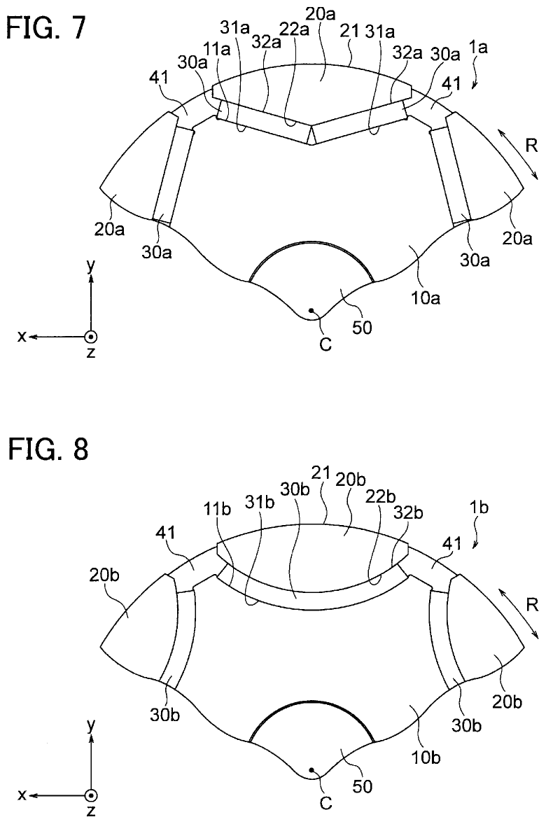

FIG. 7 is a plan view showing the configuration of a rotor 1a according to a first modification of the first embodiment. In FIG. 7, each component identical or corresponding to a component shown in FIG. 2 is assigned the same reference character as in FIG. 2. The rotor la according to the first modification of the first embodiment differs from the rotor 1 according to the first embodiment in the shape of a first rotor core 10a, the shape of a second rotor core 20a, and the arrangement of permanent magnets 30a. In other respects, the first modification of the first embodiment is the same as the first embodiment. Thus, FIG. 1 is referred to in the following description.

As shown in FIG. 7, the rotor la includes the first rotor core 10a, a plurality of second rotor cores 20a, a plurality of permanent magnets 30a, the resin part 41 and the shaft 50.

The first rotor core 10a has a surface 11a facing outward in the radial direction. A central part in the circumferential direction R of the surface 11a facing outward in the radial direction is situated on the inner side in the radial direction relative to end parts in the circumferential direction R of the surface 11a. The second rotor core 20a has a surface 22a facing inward in the radial direction. A central part in the circumferential direction R of the surface 22a facing inward in the radial direction is situated on the inner side in the radial direction relative to end parts in the circumferential direction R of the surface 22a.

Two permanent magnets 30a are arranged between the surface 11a of the first rotor core 10a facing outward in the radial direction and the surface 22a of the second rotor core 20a facing inward in the radial direction. With this configuration, the magnetic force of the rotor 1a according to the first modification of the first embodiment can be made greater than the magnetic force of the rotor 1 according to the first embodiment. In FIG. 7, the two permanent magnets 30a are arranged to form a V-shape that is convex inward in the radial direction.

The permanent magnet 30a has a first surface 31a and a second surface 32a. The first surface 31a is in contact with the surface 11a of the first rotor core 10a facing outward in the radial direction. The second surface 32a is in contact with the surface 22a of the second rotor core 20a facing inward in the radial direction. Accordingly, no gap occurs between the permanent magnet 30a and the first rotor core 10a or between the permanent magnet 30a and the second rotor core 20a. Thus, the decrease in the magnetic flux amount of the interlinkage magnetic flux flowing from the permanent magnet 30a into the coil 64 (see FIG. 1) can be prevented.

(Effect of First Modification of First Embodiment)

According to the above-described first modification of the first embodiment, the first surface 31a of the permanent magnet 30a is in contact with the surface 11a of the first rotor core 10a facing outward in the radial direction, and the second surface 32a of the permanent magnet 30a is in contact with the surface 22a of the second rotor core 20a facing inward in the radial direction. Accordingly, no gap occurs between the permanent magnet 30a and the first rotor core 10a or between the permanent magnet 30a and the second rotor core 20a. Thus, the decrease in the magnetic flux amount of the interlinkage magnetic flux can be prevented.

Further, in the rotor 1a, two permanent magnets 30a are arranged between the surface 11a of the first rotor core 10a facing outward in the radial direction and the surface 22a of the second rotor core 20a facing inward in the radial direction. With this configuration, the magnetic force of the rotor 1a according to the first modification of the first embodiment can be made greater than the magnetic force of the rotor 1 according to the first embodiment.

(Second Modification of First Embodiment)

FIG. 8 is a plan view showing the configuration of a rotor 1b according to a second modification of the first embodiment. In FIG. 8, components identical or corresponding to components shown in FIG. 2 are assigned the same reference characters as in FIG. 2. The rotor 1b according to the second modification of the first embodiment differs from the rotor 1 according to the first embodiment in the shape of a first rotor core 10b, the shape of a second rotor core 20b, and the shape of a permanent magnet 30b. In other respects, the second modification of the first embodiment is the same as the first embodiment. Thus, FIG. 1 is referred to in the following description.

As shown in FIG. 8, the rotor 1b includes the first rotor core 10b, a plurality of second rotor cores 20b, a plurality of permanent magnets 30b, the resin part 41 and the shaft 50.

A first surface 31b of the permanent magnet 30b is in contact with the surface 11b of the first rotor core 10b facing outward in the radial direction. In the second modification of the first embodiment, the first surface 31b of the permanent magnet 30b and the first radial-direction-outward-facing surface 11b of the first rotor core 10b are curved surfaces in the same shape and are in close contact with each other. Further, a second surface 32b is in contact with the surface 22b of the second rotor core 20b facing inward in the radial direction. In the second modification of the first embodiment, the second surface 32b of the permanent magnet 30b and the surface 22b of the second rotor core 20b facing inward in the radial direction are curved surfaces in the same shape and are in close contact with each other. Accordingly, no gap occurs between the permanent magnet 30b and the first rotor core 10b or between the permanent magnet 30b and the second rotor core 20b. Thus, the decrease in the magnetic flux amount of the interlinkage magnetic flux flowing from the permanent magnet 30b into the coil 64 (see FIG. 1) can be prevented.

In FIG. 8, the first surface 31b of the permanent magnet 30b is a convex surface in a semicylindrical shape as a first convex surface, and the surface 11b of the first rotor core 10b facing outward in the radial direction is a concave surface in a semicylindrical shape as a first concave surface. The second surface 32b of the permanent magnet 30b is a concave surface in a semicylindrical shape as a second concave surface, and the surface 22b of the second rotor core 20b facing inward in the radial direction is a convex surface in a semicylindrical shape as a second convex surface. Further, since the first surface 31b and the second surface 32b of the permanent magnet 30b are both curved surfaces as mentioned above, the length of the permanent magnet 30b in the circumferential direction R is longer than the length of the permanent magnet 30 in the first embodiment in the circumferential direction R. Thus, the magnetic force of the rotor 1b according to the second modification of the first embodiment can be made greater than the magnetic force of the rotor 1 according to the first embodiment.

(Effect of Second Modification of First Embodiment)

According to the above-described second modification of the first embodiment, the first surface 31b of the permanent magnet 30b is in contact with the surface 11b of the first rotor core 10b facing outward in the radial direction, and the second surface 32b of the permanent magnet 30b is in contact with the surface 22b of the second rotor core 20b facing inward in the radial direction. Accordingly, no gap occurs between the permanent magnet 30b and the first rotor core 10b or between the permanent magnet 30b and the second rotor core 20b. Thus, the decrease in the magnetic flux amount of the interlinkage magnetic flux can be prevented.

Further, according to the second modification of the first embodiment, the first surface 31b and the second surface 32b of the permanent magnet 30b are both curved surfaces. Accordingly, the length of the permanent magnet 30b in the circumferential direction R is longer than the length of the permanent magnet 30 in the first embodiment in the circumferential direction R. Thus, the magnetic force of the rotor 1b according to the second modification of the first embodiment can be made greater than the magnetic force of the rotor 1 according to the first embodiment.

(Second Embodiment)

FIG. 9 is a plan view showing the configuration of a rotor 2 according to a second embodiment. In FIG. 9, components identical or corresponding to components shown in FIG. 2 are assigned the same reference characters as in FIG. 2. The rotor 2 according to the second embodiment differs from the rotor 1 according to the first embodiment in the shape of a second rotor core 220. In other respects, the second embodiment is the same as the first embodiment. Thus, FIG. 2 is referred to in the following description.

As shown in FIG. 9, the rotor 2 includes the first rotor core 10, a plurality of second rotor cores 220, a plurality of permanent magnets 30 and a resin part 241.

The second rotor core 220 has a surface 21 facing outward in the radial direction, a surface 22 facing inward in the radial direction, and a plurality of side faces 223 connecting the surface 21 facing outward in the radial direction and the surface 22 facing inward in the radial direction.

As shown in FIG. 9, a straight line extending in a direction orthogonal to the magnetic pole central line M and orthogonal to the shaft 50 is defined as a straight line L. Further, when an angle on the magnetic pole central line M side between the straight line L and the side face 223 is θ, the angle θ satisfies the following expression(3):

θ<90° (3)

Since the angle θ satisfies the expression (2), the volume of the resin part 241 filling the gap between two second rotor cores 220 adjoining each other in the circumferential direction R is greater than the volume of the resin part 41 in the first embodiment. Specifically, as compared to the resin part 41 in the first embodiment, the resin part 241 further includes an end part 241a arranged on the outer side in the radial direction relative to an end edge 22s in the circumferential direction R of the surface 22 facing inward in the radial direction. With this configuration, the resin part 241 is capable of fixing the second rotor core 20 to the first rotor core 10 still more firmly. Accordingly, displacement of the second rotor core 20 outward in the radial direction due to centrifugal force during the rotation of the motor 100 can be prevented.

(Effect of Second Embodiment)

According to the second embodiment described above, the angle θ on the magnetic pole central line M side between the side face 223 and the straight line L extending in the direction orthogonal to the magnetic pole central line M and orthogonal to the shaft 50 is smaller than 90 degrees. With this configuration, the resin part 241 is capable of fixing the second rotor core 20 to the first rotor core 10 still more firmly. Accordingly, the displacement of the second rotor core 20 outward in the radial direction due to the centrifugal force during the rotation of the motor 100 can be prevented.

(Third Embodiment)

Next, a rotor 3 according to a third embodiment will be described. FIG. 10 is a plan view showing the configuration of the rotor 3 according to the third embodiment. In FIG. 10, components identical or corresponding to components shown in FIG. 1 are assigned the same reference characters as in FIG. 1. The rotor 3 according to the third embodiment differs from the rotor 1 according to the first embodiment in the configuration of a first rotor core 310. In other respects, the rotor 3 according to the third embodiment is the same as the rotor 1 according to the first embodiment. Thus, FIG. 1 is referred to in the following description.

As shown in FIG. 10, the rotor 3 according to the third embodiment includes the first rotor core 310, a plurality of second rotor cores 20, a plurality of permanent magnets 30, and the resin part 41.

The first rotor core 310 includes a plurality of split core parts 370 arranged in the circumferential direction R. In the third embodiment, the first rotor core 310 is split at the projection parts 12. In other words, the first rotor core 310 is split at portions each between two permanent magnets 30 adjoining each other in the circumferential direction R. Therefore, in the third embodiment, the number of the plurality of split core parts 370 corresponds to the number of magnetic poles (i.e., the number of permanent magnets 30) of the rotor 3. Specifically, the number of the plurality of split core parts 370 is the same as the number of magnetic poles of the rotor 3.

Each of the plurality of split core parts 370 has a surface 311 facing outward in the radial direction. The first surface 31 of the permanent magnet 30 is in contact with the surface 311 of the split core part 370 facing outward in the radial direction. Accordingly, no gap occurs between the permanent magnet 30 and the split core part 370. Thus, the decrease in the magnetic flux amount of the interlinkage magnetic flux can be prevented.

The plurality of split core parts 370 include a plurality of electromagnetic steel sheets stacked in the z-axis direction. In the third embodiment, a processing area in punching processing of the electromagnetic steel sheets in the manufacturing of the first rotor core 310 is the same as a plane area of the split core part 370 as viewed in the z-axis direction. In contrast, in the first embodiment, the processing area in the punching processing of the electromagnetic steel sheets 15 is the same as the plane area of the ring-shaped first rotor core 10. Thus, in the third embodiment, the processing area in the punching processing of the electromagnetic steel sheets 15 is smaller than the processing area in the punching processing of the electromagnetic steel sheets 15 in the first embodiment. Accordingly, in the third embodiment, the manufacturing yield in the manufacturing of the first rotor core 310 can be increased.

(Effect of Third Embodiment)

According to the third embodiment described above, the first surface 31 of the permanent magnet 30 is in contact with the surface 311 of the first rotor core 310 facing outward in the radial direction, and the second surface 32 of the permanent magnet 30 is in contact with the surface 22 of the second rotor core 20 facing inward in the radial direction. Accordingly, no gap occurs between the permanent magnet 30 and the first rotor core 310 or between the permanent magnet 30 and the second rotor core 20. Thus, the decrease in the magnetic flux amount of the interlinkage magnetic flux can be prevented.

Further, according to the third embodiment, the first rotor core 310 includes a plurality of split core parts 370. Accordingly, the manufacturing yield in the manufacturing of the first rotor core 310 can be increased.

(First Modification of Third Embodiment)

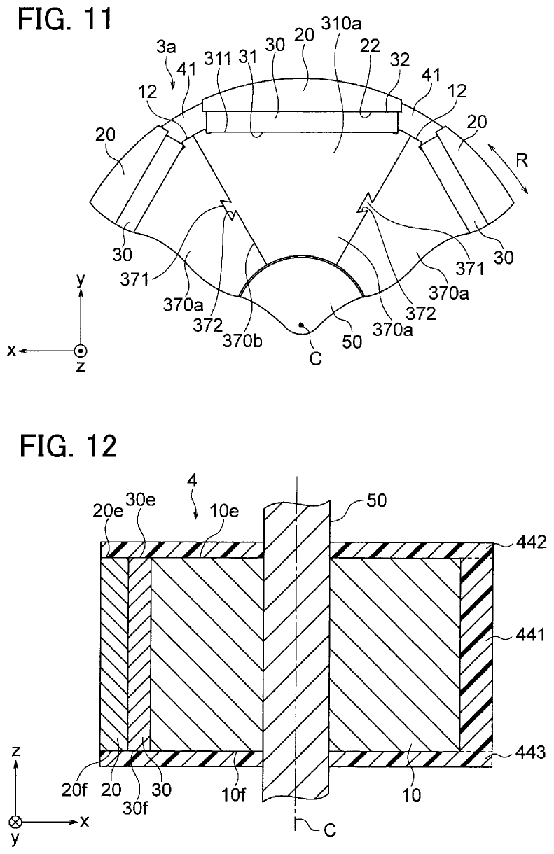

Next, a rotor 3a according to a first modification of the third embodiment will be described. FIG. 11 is a plan view showing the configuration of the rotor 3a according to the first modification of the third embodiment. In FIG. 11, components identical or corresponding to components shown in FIG. 10 are assigned the same reference characters as in FIG. 10. The rotor 3a according to the first modification of the third embodiment differs from the rotor 3 according to the third embodiment in the shape of a first rotor core 310a.

As shown in FIG. 11, the first rotor core 310a includes a plurality of split core parts 370a arranged in the circumferential direction R. Each of the plurality of split core parts 370a includes a convex part 371 as a first fitting part and a concave part 372 as a second fitting part that is fitted onto the convex part 371 of another split core part 370a adjoining in the circumferential direction R. As above, the concave part 372 of one of two split core parts 370a adjoining each other in the circumferential direction R is fitted onto the convex part 371 of the other of the two split core part 370a, and thus the two adjoining split core parts 370a are firmly fixed together. Accordingly, rigidity of the first rotor core 310a can be increased.

(Effect of First Modification of Third Embodiment)

According to the above-described first modification of the third embodiment, one of two adjoining split core parts 370a among the plurality of split core parts 370a includes the convex part 371 and the other of the two split core parts 370a includes the concave part 372 that is fitted onto the convex part 371. With this configuration, the two adjoining split core parts 370a are firmly fixed together. Accordingly, the rigidity of the first rotor core 310a can be increased.

(Fourth Embodiment)

Next, a rotor 4 according to a fourth embodiment will be described. FIG. 12 is a cross-sectional view showing the configuration of the rotor 4 according to the fourth embodiment. In FIG. 12, components identical or corresponding to components shown in FIGS. 1 to 3 are assigned the same reference characters as in FIGS. 1 to 3. The rotor 4 according to the fourth embodiment differs from the rotor 1 according to the first embodiment in that the rotor 4 further includes second resin parts 442 and 443 covering the end faces of the first rotor core 10, the second rotor cores 20 and the permanent magnets 30 in the axial direction. In other respects, the rotor 4 according to the fourth embodiment is the same as the rotor 1 according to the first embodiment. Thus, FIG. 2 is referred to in the following description.

As shown in FIG. 12, the rotor 4 includes the first rotor core 10, a plurality of second rotor cores 20, a plurality of permanent magnets 30, a first resin part 441, the shaft 50, and a plurality of second resin parts 442 and 443.

The first resin part 441 fills the gap between two second rotor cores 20 (see FIG. 2) adjoining each other in the circumferential direction R among the plurality of second rotor cores 20.

The second resin part 442 is arranged to cover one end faces 10e, 20e and 30e of the first rotor core 10, the second rotor cores 20 and the permanent magnets 30 in the axial direction. The second resin part 443 is arranged to cover the other end faces 10f, 20f and 30f of the first rotor core 10, the second rotor cores 20 and the permanent magnets 30 in the axial direction. Accordingly, the plurality of second rotor cores 20 and the plurality of permanent magnets 30 can be fixed to the first rotor core 10 more firmly. Since the second resin parts 442 and 443 cover the end faces 30e and 30f of the permanent magnet 30 in the axial direction, the permanent magnet 30 is not exposed to air. The occurrence of rust on the permanent magnet 30 can be inhibited and excellent magnetic properties of the permanent magnet 30 can be maintained.

The second resin parts 442 and 443 and the first resin part 441 are formed integrally. Accordingly, a plurality of first resin parts 441 arranged in the circumferential direction R are connected together via the second resin parts 442 and 443, and thus the rigidity of the rotor 4 can be increased. Incidentally, the rotor 4 can be implemented even if the second resin parts 442 and 443 are not formed integrally with the first resin part 441. Further, the rotor 4 may also be configured to include only one of the plurality of second resin parts 442 and 443.

(Effect of Fourth Embodiment)

According to the fourth embodiment described above, the rotor 4 further includes the second resin parts 442 and 443 arranged to cover the end faces in the axial direction of the first rotor core 10, the second rotor cores 20 and the permanent magnets 30 in the axial direction. With this configuration, the plurality of second rotor cores 20 and the plurality of permanent magnets 30 can be fixed to the first rotor core 10 more firmly.

Further, according to the fourth embodiment, the second resin parts 442 and 443 respectively cover the end faces 30e and 30f of the permanent magnet 30 in the axial direction. With this configuration, the permanent magnet 30 is not exposed to air. Accordingly, the occurrence of rust on the permanent magnet 30 can be inhibited and excellent magnetic properties of the permanent magnet 30 can be maintained.

Furthermore, according to the fourth embodiment, the second resin part 442 and 443 are connected to the first resin part 441. Accordingly, a plurality of first resin parts 441 arranged in the circumferential direction R are connected together via the second resin parts 442 and 443, by which the rigidity of the rotor 4 can be increased.

(Fifth Embodiment)

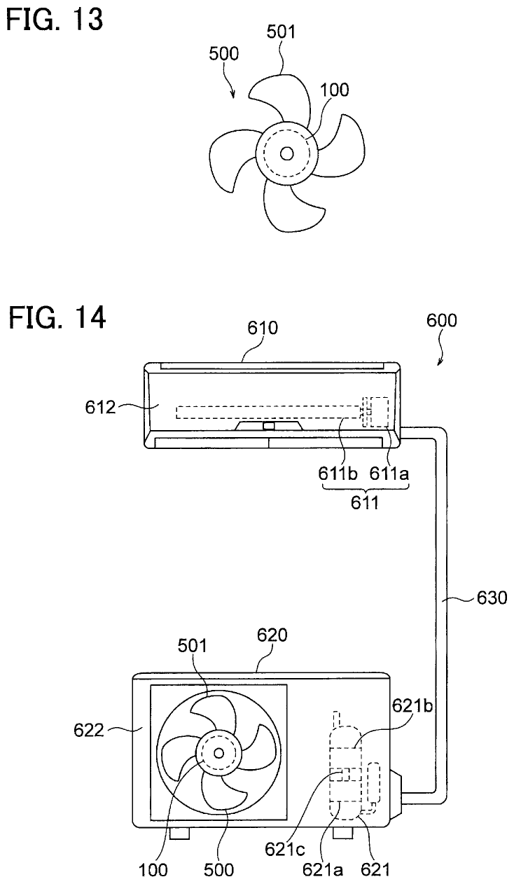

Next, a blower 500 including the motor 100 shown in FIG. 1 will be described. FIG. 13 is a diagram showing the configuration of the blower 500 according to a fifth embodiment.

As shown in FIG. 13, the blower 500 includes the motor 100 and a fan 501 that is driven by the motor 100. The fan 501 is attached to the shaft of the motor 100. When the shaft of the motor 100 rotates, the fan 501 is rotated and an airflow is generated. The blower 500 is used as an outdoor blower of an outdoor unit 620 of an air conditioner 600 shown in FIG. 14 which will be explained later, for example. In this case, the fan 501 is a propeller fan, for example.

(Effect of Fifth Embodiment)

According to the fifth embodiment described above, the blower 500 includes the motor 100 described in the first embodiment. A decrease in the output torque of the motor 100 can be prevented since the motor 100 according to the first embodiment is capable of preventing the decrease in the magnetic flux amount of the interlinkage magnetic flux as described earlier. Accordingly, a decrease in the output power of the blower 500 can also be prevented.

(Sixth Embodiment)

Next, an air conditioner 600 including the blower 500 shown in FIG. 13 will be described. FIG. 14 is a diagram showing the configuration of the air conditioner 600 according to a sixth embodiment.

As shown in FIG. 14, the air conditioner 600 includes an indoor unit 610, an outdoor unit 620 and a refrigerant pipe 630. The indoor unit 610 and the outdoor unit 620 are connected together by the refrigerant pipe 630, by which a refrigerant circuit in which refrigerant circulates is formed. The air conditioner 600 is capable of executing an operation such as a cooling operation of blowing cool air from the indoor unit 610 or a heating operation of blowing warm air, for example.

The indoor unit 610 includes an indoor blower 611 and a housing 612 that accommodates the indoor blower 611. The indoor blower 611 includes a motor 611a and a fan 611b that is driven by the motor 611a. The fan 611b is attached to the shaft of the motor 611a. By the rotation of the shaft of the motor 611a, the fan 611b is rotated and an airflow is generated. The fan 611b is a cross-flow fan, for example.

The outdoor unit 620 includes the blower 500 as the outdoor blower, a compressor 621, and a housing 622 that accommodates the blower 500 and the compressor 621. The compressor 621 includes a compression mechanism unit 621a and a motor 621b that drives the compression mechanism unit 621a. The compression mechanism unit 621a and the motor 621b are connected to each other by a rotary shaft 621c. Incidentally, the motor 100 according to the first embodiment may be employed for the motor 621b of the compressor 621.

For example, in the cooling operation of the air conditioner 600, heat released when the refrigerant compressed by the compressor 621 is condensed in a condenser (not shown) is discharged to the outside of the room by the air blown by the blower 500. Incidentally, the blower 500 according to the fifth embodiment may be employed not only as the outdoor blower of the outdoor unit 620 but also as the above-described indoor blower 611. Further, the blower 500 may be included not only in the air conditioner 600 but also in different types of devices.

The outdoor unit 620 further includes a four-way valve (not shown) that switches a flow direction of the refrigerant. The four-way valve of the outdoor unit 620 causes high-temperature and high-pressure refrigerant gas sent out from the compressor 621 to flow to a heat exchanger of the outdoor unit 620 in the cooling operation, or to a heat exchanger of the indoor unit 610 in the heating operation.

(Effect of Sixth Embodiment)

According to the sixth embodiment described above, the air conditioner 600 includes the blower 500. As mentioned earlier, the decrease in the output power of the blower 500 can be prevented since the blower 500 includes the motor 100 described in the first embodiment. Accordingly, a decrease in the output power of the air conditioner 600 can also be prevented.

1. A rotor comprising:
a first rotor core;
a plurality of permanent magnets each having a first surface in contact with a first radial-direction-outward-facing surface of the first rotor core and a second surface facing outward in a radial direction;
a plurality of second rotor cores each having a surface facing inward in the radial direction, the surface of each of the plurality of second rotor cores facing inward in the radial direction being in contact with the second surface of corresponding one of the plurality of permanent magnets; and
a first resin part provided at a region between adjoining second rotor cores among the plurality of second rotor cores, the region being located on an inner side in the radial direction with respect to a second radial-direction-outward facing surface which is a surface of the second rotor core facing outward in the radial direction, and the region being located on an outer side in the radial direction with respect to the first surface.

2. The rotor according to claim 1, wherein the first surface and the first radial-direction-outward-facing surface are both flat surfaces and are in close contact with each other, and
wherein the second surface and the surface facing inward in the radial direction are both flat surfaces and are in close contact with each other.

3. The rotor according to claim 1, wherein the first surface and the first radial-direction-outward-facing surface are curved surfaces in a same shape and are in close contact with each other, and
wherein the second surface and the surface facing inward in the radial direction are curved surfaces in a same shape and are in close contact with each other.

4. The rotor according to claim 3, wherein the first surface is a first convex surface in a semicylindrical shape,
wherein the first radial-direction-outward-facing surface is a first concave surface in a semicylindrical shape that is in close contact with the first convex surface,
wherein the second surface is a second concave surface in a semicylindrical shape, and
wherein the surface facing inward in the radial direction is a second convex surface in a semicylindrical shape that is in close contact with the second concave surface.

5. The rotor according to claim 1, wherein the second rotor core further has a second radial direction outward facing surface and a side face connecting the second radial-direction-outward-facing surface and the surface facing inward in the radial direction, and
wherein when θ represents an angle on the magnetic pole central line side between the side face and a straight line extending in a direction orthogonal to a rotation axis of the rotor and orthogonal to a magnetic pole central line connecting a magnetic pole of the permanent magnet and a rotation axis of the rotor, the angle θ satisfies θ<90°.

6. The rotor according to claim 1, wherein the first rotor core includes a plurality of split core parts arranged in a circumferential direction.

7. The rotor according to claim 6, wherein one of two adjoining split core parts among the plurality of split core parts includes a first fitting part, and
wherein the other of the two split core parts includes a second fitting part that is fitted with the first fitting part.

8. The rotor according to claim 1, further comprising a second resin part that is arranged to cover end faces of the first rotor core, the permanent magnets and the second rotor cores in an axial direction of a rotation axis of the rotor.

9. The rotor according to claim 8, wherein the second resin part and the first resin part are formed integrally.

10. The rotor according to claim 1, wherein the permanent magnet is a rectangular parallelepiped.

11. The rotor according to claim 1, wherein the permanent magnet is a sintered magnet.

12. The rotor according to claim 1, wherein the permanent magnet is a neodymium rare-earth magnet.

13. A motor comprising:
the rotor according to claim 1; and
a stator core.

14. The motor according to claim 13, wherein the stator core includes tooth parts, and
wherein when a represents an angle on the first resin part side between a first straight line connecting a rotation axis of the rotor and one end part in a circumferential direction of a third radial-direction-outward-facing surface which is a surface of the first resin part facing outward in a radial direction about the rotation axis and a second straight line connecting the rotation axis and the other end part of the third radial-direction-outward-facing surface in the circumferential direction, T represents a number of the tooth parts, and N represents a number of magnetic poles of the rotor, α>360°(T−N)/(T·N) is satisfied.

15. The motor according to claim 13, wherein the stator core includes a yoke part and tooth parts,
wherein the tooth part includes a tooth extension part that extends inward in a radial direction of the stator core from the yoke part and a tooth tip part that is arranged on an inner side in the radial direction relative to the tooth extension part and is wider in a circumferential direction of the stator core than the tooth extension part, and
wherein a length of the second rotor core in the circumferential direction is less than or equal to a length of the tooth tip part in the circumferential direction.

16. A blower comprising:
the motor according to claim 13; and
a fan that is driven by the motor.

17. An air conditioner comprising the blower according to claim 16.

18. A manufacturing method of a rotor, comprising:
a step of forming a first structure that includes a first rotor core, a plurality of permanent magnets each having a first surface in contact with a first radial-direction-outward-facing surface of the first rotor core and a second surface facing outward in a radial direction, and a plurality of second rotor cores each having a surface facing inward in the radial direction, the surface of each of the plurality of second rotor cores facing inward in the radial direction being in contact with the second surface of corresponding one of the plurality of permanent magnets; and
a step of forming a first resin part by filling a region between adjoining second rotor cores among the plurality of second rotor cores with resin, the region being located on an inner side in the radial direction with respect to a second radial-direction-outward facing surface which is a surface of the second rotor core facing outward in the radial direction, and the region being located on an outer side in the radial direction with respect to the first surface.
